(19) United States
(12) Patent Application Publication
(10) Pub. No.: US 2023/0250700 A1
(43) Pub. Date: Aug. 10, 2023

(54) COMPOSITE SWIVEL ASSEMBLY

(71) Applicant: SPM Oil & Gas Inc., Ft. Worth, TX (US)

(72) Inventor: Jacob A. Bayyouk, Richardson, TX (US)

(73) Assignee: SPM Oil & Gas Inc., Ft. Worth, TX (US)

(21) Appl. No.: 18/161,214

(22) Filed: Jan. 30, 2023

Related U.S. Application Data
(63) Continuation of application No. 63/306,913, filed on Feb. 4, 2022.

(51) Int. Cl. E21B 17/05; F16L 27/08

(52) U.S. Cl. CPC E21B 17/05; F16L 27/0828

(57) ABSTRACT

A swivel assembly is provided with a first pipe section having a first end fitting having an inner surface and an outer surface, at least a portion of the first end fitting is formed of a corrosion-resistant material. The swivel assembly further includes a second pipe section having a second end fitting having an inner surface and an outer surface, at least a portion of the second pipe section formed of a corrosion-resistant material. The swivel assembly further includes a swivel joint, the swivel joint rotatably securing the first and second end fittings together along a central axis, the swivel joint formed of a material having a greater hardness than the material, from which at least a portion of the second pipe section is formed.

### CROSS-REFERENCE TO RELATED APPLICATIONS

This application claims the benefit of and priority to U.S. Patent Application No. 63/306,913, filed Feb. 4, 2022, the entire disclosure of which is incorporated by reference herein.

### TECHNICAL FIELD

The present disclosure relates to swivel assemblies for high pressure well service applications and, in particular, to a composite swivel assembly having a hardened swivel joint, and even more particularly, to a composite swivel assembly having hardened swivel joints formed with hardened inserts and/or sleeves.

### BACKGROUND

High pressure well service applications require the use of swivel assemblies to interconnect various plumbing configurations. A swivel assembly typically includes male and female connectors that are joined and sealed, but which permit swivel action between them. Circumferential bearing raceways are formed in the male and female connectors to capture ball bearings therebetween to facilitate the swiveling action. Swivel joints are required to perform under extreme conditions, such as handling fluids that contain abrasives that cause erosion of the joint components, high pressures, and extreme temperatures.

The swivel assemblies are often formed of multiple pipe sections of low alloy steel of 4715 grade. However, to facilitate a rotational movement of the components of the swivel assemblies, the raceways require hard surfaces configured to dispose the bearings therein. Typically hardening is performed using different heat treatment methods, e.g. carburizing of the respective surfaces of the raceways disposed in both ends of the first and second pipes and the respective adjacent surfaces. Corrosion, pitting, as well as erosion assisted corrosion oftentimes occur within certain areas of the pipe sections. As a result of such corrosion and pitting, the pipe sections may have an increased stress concentration, which can contribute to cracking causing failure of the swivel assemblies. There is a need to address these deficiencies.

### SUMMARY

According to a first aspect, there is provided a swivel assembly including a first pipe section having a first end fitting and a second pipe section having a second end fitting corresponding to and receiving the first end fitting, each of the first and second end fittings having an inner surface and an outer surface. A swivel joint rotatably secures, via the corresponding first and second end fittings, the first and second pipe sections together along a central axis to define a fluid passageway therethrough. The swivel joint includes a sleeve disposed on the outer surface of the first end fitting and an insert disposed on the inner surface of the second end fitting. The insert includes at least one insert groove and the sleeve includes at least one sleeve groove corresponding to each insert groove such that when the first and second pipe sections are secured together along the central axis, corresponding ones of the sleeve and insert grooves are aligned to form a bearing raceway for supporting a plurality of ball bearings therein.

According to one embodiment, the swivel assembly wherein the outer surface of the first end fitting to receive at least a portion of the sleeve therearound.

According to yet another embodiment, the swivel assembly wherein the inner surface of the second end fitting defines a counterbore configured to receive at least a portion of the insert therein.

In still another embodiment, the at least one of the sleeve and the insert are formed of a hardened steel.

In yet another embodiment, the insert is threadedly secured to the second end fitting.

In still another embodiment, the sleeve is threadedly secured to the first end fitting.

In another embodiment, the sleeve is press-fit onto the first end fitting.

In still other embodiments, the insert is removably attached to the second end fitting.

According to other embodiments, the first end fitting is a male fitting and the second end fitting is a female fitting for receiving the male fitting.

In still another embodiment, the swivel joint is formed of hardened low or high alloy steel material.

According to a second aspect, there is provided a method of assembling a swivel assembly. The method includes coupling a sleeve to an outer surface of a first end fitting of a first pipe section, the sleeve having at least one sleeve groove disposed on an outer surface thereof, the at least one sleeve groove configured to fit a plurality of ball bearings therein. The method further includes coupling an insert to an inner surface of a second end fitting of a second pipe section, the insert having at least one insert groove disposed on an inner surface thereof, at least one insert groove configured to align with the at least one sleeve groove to define at least one bearing raceway therebetween when the swivel assembly is fully assembled. The method further includes inserting the sleeve into the insert, thereby fluidly coupling the first and second pipe sections via the swivel assembly. The method also includes disposing the plurality of ball bearings into the at least one bearing raceway of the swivel assembly.

According to one embodiment, the method includes engaging, via corresponding threads, the sleeve and the first end fitting.

According to another embodiment, the method includes providing the outer surface of the first end fitting that defines a reduced outer diameter surface, and coupling the sleeve to the outer surface, such coupling includes disposing the sleeve around the reduced outer diameter surface.

In still other embodiments, the method includes engaging, via corresponding threads, the insert and the second end fitting.

In still other embodiments, the method includes providing an insert formed of a hardened low or high alloy steel material.

In still other embodiments, the first and second end fittings are formed of a corrosion-resistant material (such as, for example, stainless steel or polycarbonate material) and the insert and sleeve are formed of a different material (such as, for example, hardened low or high alloy steel).

According to a third aspect, there is provided a swivel assembly formed with a first pipe section having a first end fitting having an inner surface and an outer surface, at least a portion of the first pipe section formed of a corrosion-resistant material (such as, for example, stainless steel). The swivel assembly also includes a second pipe section having a second end fitting having an inner surface and an outer surface, at least a portion of the second pipe section formed of the corrosion-resistant material (such as, for example, stainless steel). The assembly also includes a swivel joint, the swivel joint rotatably securing the first and second end fittings together along a central axis, the swivel joint formed of a material having a greater hardness than the corrosion-resistant material of the first and second pipe sections. For example, such material from which the swivel joint is formed may be a hardened low or high alloy steel material.

According to some embodiments, the swivel joint includes a sleeve disposed on the outer surface of the first end fitting and an insert disposed on the inner surface of the second end fitting.

In still other embodiments, the sleeve is threadedly secured to the first end fitting.

In yet other embodiments, the insert is threadedly secured to the second end fitting.

### BRIEF DESCRIPTION OF THE DRAWINGS

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals denote like elements.

FIG. 1 illustrates a section view of a swivel assembly, in which a hardened swivel joint is employed to advantage;

FIG. 2 is a detail view of a portion of the swivel assembly of FIG. 1 illustrating the swivel joint of FIG. 1 having a sleeve and an insert.

FIG. 3 is an exploded view of the swivel assembly of FIG. 2.

FIG. 4 is a section view of the swivel assembly of FIG. 1 illustrating a pipe with female and male end fittings having the sleeve and the insert.

FIG. 5A is a detail view of another embodiment of the swivel assembly illustrating the male end fitting having the sleeve.

FIG. 5B is an exploded view of the swivel assembly of FIG. 5A.

FIG. 6A is a detail view of another embodiment of the swivel assembly illustrating the female end fitting having the insert.

FIG. 6B is an exploded view of the swivel assembly of FIG. 6A.

### DETAILED DESCRIPTION

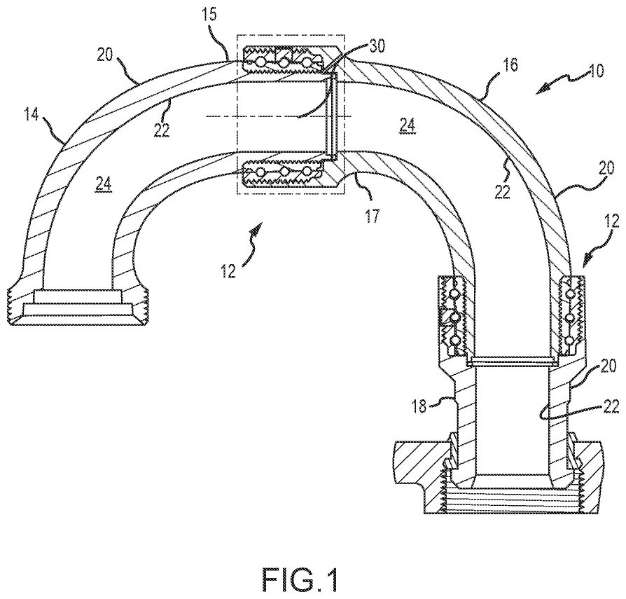

FIG. 1 is an illustration of a swivel assembly 10 in which a hardened swivel joint 12 is employed to advantage. In the embodiment illustrated in FIG. 1, the swivel assembly 10 includes a first pipe section 14, a second pipe section 16, and a third pipe section 18, each rotatable with respect to each other via a respective swivel joint 12. Each of the pipe sections 14, 16 and 18 are formed having an outer surface 20 and an inner surface 22, at least a portion of the inner surface 22 forming a fluid passageway 24 for directing fluid through the swivel assembly 10 during operation. It should be understood, however, that the swivel assembly 10 may be otherwise configured. For example, in some embodiments, the swivel assembly 10 may include a greater or fewer number of pipe sections 14, 16 and/or 18 and associated swivel joints 12. During operation, corrosion, pitting, as well as erosion assisted corrosion can oftentimes increase stress concentration, which can contribute to cracking within the pipe sections 14, 16 and/or 18. To reduce or substantially eliminate the likelihood of such cracking, the pipe sections 14, 16 and/or 18 may be formed of a corrosion-resistant material, such as, for example, a stainless steel grade material or a polycarbonate material. However, in order to maintain sufficient hardness within the swivel joints 12, at least a portion of the swivel joints 12, as explained in greater detail below, are formed of one or more hardened materials such as, for example, a hardened low or high alloy steel, in order to provide hardened surfaces therein that are more conducive to typical operating conditions.

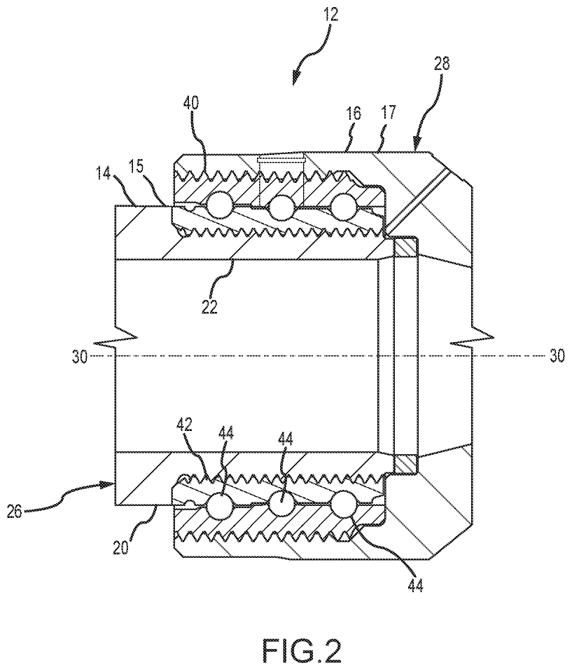

Referring specifically to FIG. 2, the swivel joint 12 is formed having a first pipe section 14 having a first end fitting 15 and a second pipe section 16 having a second end fitting 17. In the embodiment illustrated in FIG. 2, the first end fitting 15 defines a male fitting or a male connector 26 and the second end fitting 17 defines a female fitting or female connector 28 that corresponds to the male connector 26. The female connector 28 is sized to receive at least a portion of the male connector 26 therein so as to coaxially interconnect along a central axis 30. In operation, the swivel joint 12 permits the male and female connectors 26 and 28, and thus, pipe sections 14 and 16 to pivot and/or otherwise rotate about the central axis 30 while still maintaining a high pressure seal therebetween.

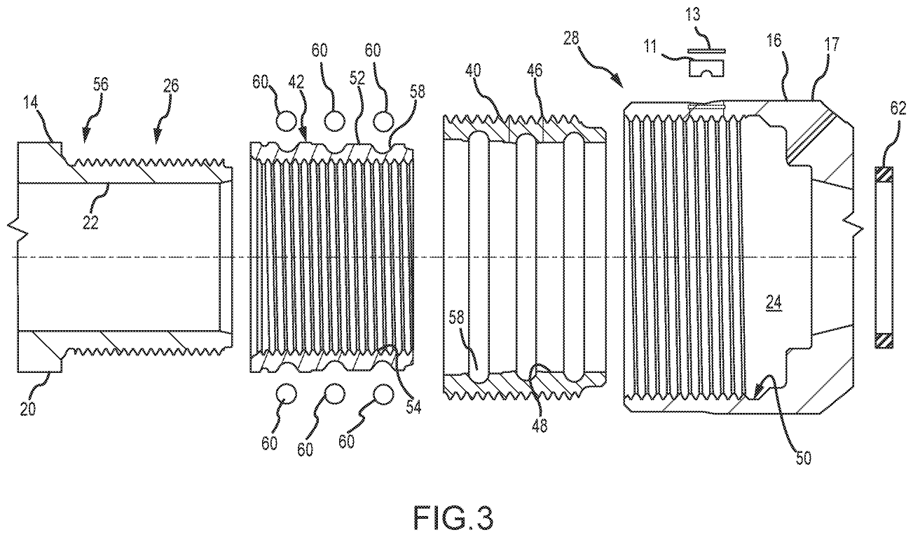

With continued reference to the embodiment illustrated in FIGS. 2 and 3, the swivel joint 12 includes an insert 40 and a sleeve 42, the insert 40 positioned at least partially around the sleeve 42 in order to, as explained in greater detail below, provide hardened surfaces to support a plurality of raceways 44 therebetween (shown in FIG. 2). A plurality of ball bearings 60 (shown in FIG. 3) are disposed within corresponding ones of the plurality of the raceways 44 to facilitate the rotational movement of the swivel joint 12. While FIG. 3 illustrates the plurality of bearings as the ball bearings 60, it should be understood that the bearings 60 may be roller bearings, such as, for example, linear roller bearings, or any other type of bearings.

In the embodiment illustrated in FIGS. 2 and 3, the insert 40 is formed having an outer surface 46 and an inner surface 48 and is sized to be disposed and otherwise secured within a counterbore 50 of the female connector 28 of the second pipe section 16. The counterbore 50 may be defined on an inner surface 22 of the second end fitting 17. The counterbore 50 may be configured to receive at least a portion of the insert 40 therein. Likewise, the sleeve 42 is formed having an outer surface 52 and an inner surface 54 and is sized to be disposed and otherwise secured around a reduced outer diameter surface 56 of the male connector 26 of the first pipe section 14. The reduced outer diameter surface 56 of the first end fitting 15 may define a reduced outer diameter thereof. The reduced outer diameter surface 56 may be configured to receive at least a portion of the sleeve 42 therearound.

When the insert 40 is disposed around the sleeve 42, the inner surface 48 of the insert 40 is positioned adjacent the outer surface 52 of the sleeve 42 so as to provide surfaces to accommodate the raceways 44. In particular, and with specific reference to FIG. 3, the inner surface 48 of the insert 40 includes a plurality of grooves 58, which are positioned and otherwise formed on the inner surface 48 to align with a plurality of corresponding grooves 58 that are positioned and otherwise formed on the outer surface 52 of the sleeve 42, the grooves 58 forming the raceways 44, such that, when aligned, support a plurality of ball bearings 60 therein. In some embodiments, a plug 11 and a pin 13 may be used to close a passageway, through which the plurality of ball bearings 60 are inserted within the at least one raceway 44. In some embodiments, a sealing element 62 is disposed between an end of the first end fitting 15 and the inner surface 22 of the second end fitting 17. The sealing element 62 substantially eliminates or prevents access of fluid from the passageway 24 to an area, in which the raceways 44 and the plurality of ball bearings 60 are disposed.

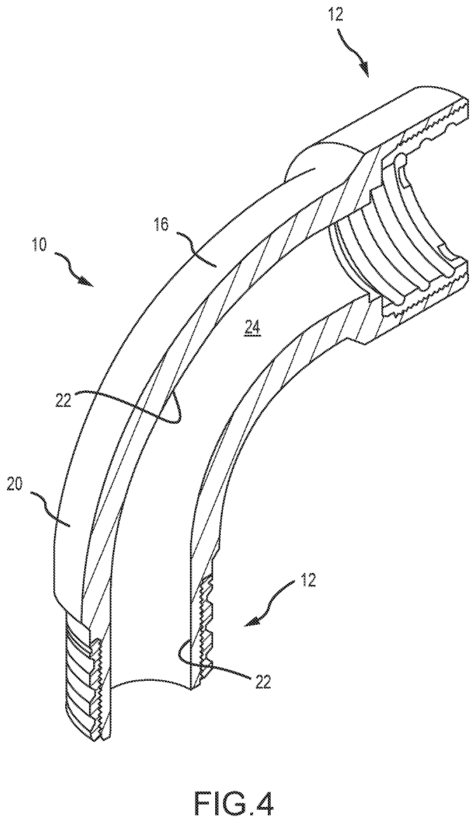

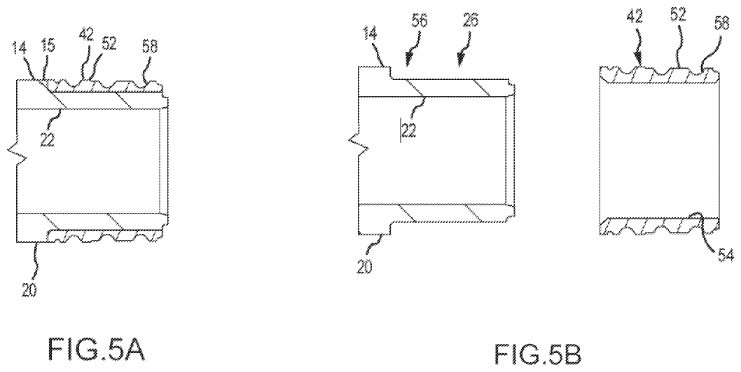

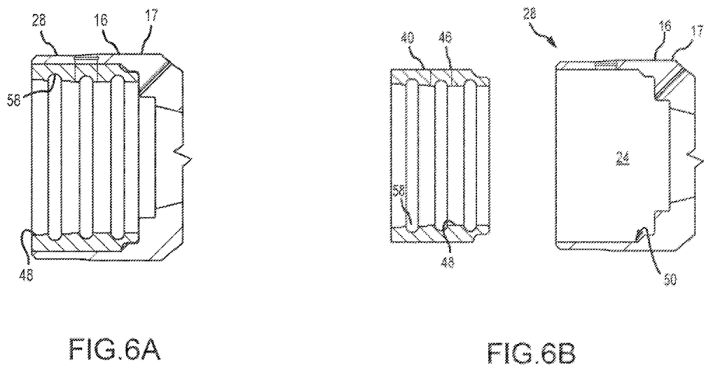

In the embodiment illustrated in FIGS. 1, 2, and 4, the insert 40 is threadably secured to the female connector 28. In particular, the outer surface 46 of the insert 40 is threaded to engage with corresponding threads formed in the counterbore 50 of the female connector 28. Likewise, threads are formed on at least a portion of the inner surface 54 of the sleeve 42 so as to engage corresponding threads disposed in the reduced outer diameter surface 56 of the male connector 26 (best illustrated in FIG. 3). It should be understood, however, that other connection configurations and/or securing methods may be employed. For example, as best illustrated in FIGS. 5A, 5B, 6A, and 6B, a shrink and press fit type connection may be employed. In still other embodiments, a pinned and/or keyed connection, a bolted connection, a staking connection, an adhesive, welding or any combination thereof may be employed to secure the aforementioned components of the swivel joint 12.

While FIGS. 1-3 illustrate that each swivel joint 12 includes one insert 40 and a corresponding sleeve 42, it should be understood that other configurations may be employed. For example, in some embodiments, a swivel joint 12 may only employ a sleeve 42 (i.e., without the corresponding insert 40). In other embodiments, a swivel joint 12 may employ only an insert 40 (i.e., without the sleeve 42). Accordingly, at least one raceway 44 may be integrally formed within the outer surface 20 of the first pipe section 14 and/or the inner surface 22 of the second pipe section 16 in embodiments when only the insert 40 or only the sleeve 42 are employed, respectively. In such configurations, it should be understood that the female connector counterbore 50 and the male connector reduced outer diameter surface 56 may be unnecessary and the raceways 44 may be formed directly on inner and outer surfaces 22 and 20, respectively.

According to an embodiment disclosed herein, the first and second pipe sections 14 and 16 are selected from a corrosion-resistant material, such as, for example, a stainless steel or a polycarbonate material. The inserts 40 and sleeves 42 are formed of a different material, such as, for example, a low alloy steel and/or a high alloy steel that is hardened in order to provide hardened surfaces for the raceways 44 extending annularly around the sleeve outer surfaces 52 and the insert inner surfaces 48.

According to embodiments disclosed herein, inserts 40 and sleeves 42 may be formed in a shape of a clam shell. For example, a first half-portion of the sleeve 42 (i.e., the portion of the sleeve 42 disposed on a first side of the central axis 30) may be disposed adjacent to or otherwise aligned with a second half-portion of the sleeve 42 (i.e., the portion of the sleeve 42 disposed on the opposite side of the central axis 30). Once adjacently positioned, the first and second portions of the sleeve 42 may be secured together via welding, an adhesive, or any other method of attachment.

Similarly, a first half-portion of the insert 40 (i.e., the portion of the insert 40 disposed on a first side of the central axis 30) may be coupled to a second half-portion of the insert 40 (i.e., the portion of the insert 40 disposed on the opposite side of the central axis 30). Once adjacently positioned, the first and second portions of the insert 40 may be secured together via welding, an adhesive or any other method of attachment.

In other embodiments, the insert 40 and the sleeve 42 may be stamped. For example, the sleeve 42 may be formed by a stamping machine forming the sleeve 42 as a rolled one-piece or two-piece part. Similarly, in some embodiments, the insert 40 may be formed via a stamping method such that a stamping machine forms the insert 40 as a rolled one-piece or two-piece part.

In other embodiments, the insert 40 and/or the sleeve 42 may be formed via a hardening method, wherein the insert 40 and/or the sleeve 42 (including their respective inner surfaces 48, 54 and outer surfaces 46, 52) are hardened. Before such hardening, however, the insert 40 and/or the sleeve 42 are initially machined to their operable shapes. Thereafter, they may undergo induction heat treatment, carburizing, nitriding, laser heat treatment, quench and tempering optimization or any other suitable method of heat treatment or combination thereof. Alternatively, the insert 40 and/or the sleeve 42 are machined to a near or partial operable shape, and subsequently hardened as previously described. After hardening, the insert 40 and/or the sleeve 42 are machined to their operable shapes.

According to some embodiments, a selective hardening of the sleeve 42 may be employed. For example, the sleeve outer surface 52 is machined to its operable shape. Thereafter, the sleeve 40 is carburized except for the outer surface 52. Thereafter, the raceways 44 formed in the sleeve 40 undergo induction heat treatment, carburizing, nitriding, laser heat treatment, quench and tempering optimization or any other suitable method of heat treatment or combination thereof. Similar selective hardening of the insert 40 may also be optionally employed. For example, the insert inner surface 48 is machined to its operable shape. The insert 40 is then carburized with exception to the insert inner surface 48. Thereafter, the raceways 44 of the insert 40 undergo subsequent hardening as previously described.

According to other embodiments, a relatively soft outer surface method for machining and treatment of the sleeve 42 may be employed. During such manufacturing method, an extra material is left on the relatively soft outer surface 52 of the sleeve 42. After heat treatment, the outer surface 52 is machined to its final operable shape. Similarly, a relatively soft inner surface method for machining and treatment of the insert 40 may be employed. During such manufacturing method, extra material is left on the relatively soft inner surface 48 of the insert 40. After heat treatment, the inner surface 48 is machined to its final operable shape.

According to embodiment disclosed herein, a method of assembling the swivel assembly 10 is provided. In the embodiment illustrated in FIGS. 1-3, the first and second pipe sections 14 and 16 are provided. An insert 40 is formed having at least one raceway 44 disposed in the insert inner surface 48 and is sized to receive a plurality of ball bearings 60. A sleeve 42 is formed having at least one raceway 44 disposed on the sleeve outer surface 52 and is also sized to receive the plurality of bearings 60.

The insert 40 is then installed and secured at the inner surface 22 of the second pipe section 16 and the sleeve 42 is installed and secured on the outer surface 20 of the first pipe section 14. In particular, the insert 40 is disposed within the counterbore 50 of the female connector 28 and the sleeve 42 is disposed around the reduced outer diameter surface 56 of the male connector 26. As previously described, the insert 40 and the sleeve 42 may be attached to the second and first pipe sections 16 and 14 via a threaded connection, as best illustrated in FIGS. 1-4. However, it should be understood that any other method of attachment (i.e., welding, adhesive, bolting, staking, shrink fit, press fit, etc.) may be used. For example, in the embodiment illustrated in FIGS. 5A and 5B, the male end fitting 26 is coupled to the sleeve 42 via one of the non-threaded methods previously described including, but not limited to use of welding, adhesives, staking, shrink fitting, press fitting or combinations thereof. Likewise, in the embodiments illustrated in FIGS. 6A and 6B, the female end fitting 28 is coupled to the insert 40 via one of the non-threaded methods previously described including, but not limited to use of welding, adhesives, staking, shrink fitting, press fitting or combinations thereof.

The insert and sleeve 40 and 42 are positioned such that the respective grooves 58 are aligned to form the raceways 44 for receiving the ball bearings 60 therein.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments and it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A swivel assembly, comprising:
a first pipe section having a first end fitting and a second pipe section having a second end fitting corresponding to and receiving the first end fitting, each of the first and second end fittings having an inner surface and an outer surface; and
a swivel joint rotatably securing, via the corresponding first and second end fittings, the first and second pipe sections together along a central axis to define a fluid passageway therethrough, the swivel joint including:
a sleeve disposed on the outer surface of the first end fitting and an insert disposed on the inner surface of the second end fitting, wherein the insert includes at least one insert groove and the sleeve includes at least one sleeve groove corresponding to each insert groove such that when the first and second pipe sections are secured together along the central axis, corresponding ones of the sleeve and insert grooves are aligned to form a bearing raceway for supporting a plurality of ball bearings therein.

2. The swivel assembly of claim 1, wherein the outer surface of the first end fitting defines a reduced outer diameter configured to receive at least a portion of the sleeve therearound.

3. The swivel assembly of claim 1, wherein the inner surface of the second end fitting defines a counterbore configured to receive at least a portion of the insert therein.

4. The swivel assembly of claim 1, wherein at least one of the sleeve and the insert are formed of a hardened steel.

5. The swivel assembly of claim 1, wherein the insert is threadedly secured to the second end fitting.

6. The swivel assembly of claim 1, wherein the sleeve is threadedly secured to the first end fitting.

7. The swivel assembly of claim 1, wherein the sleeve is press-fit onto the first end fitting.

8. The swivel assembly of claim 1, wherein the insert is removably attached to the second end fitting.

9. The swivel joint of claim 1, wherein the first end fitting is a male fitting and the second end fitting is a female fitting for receiving the male fitting.

10. The swivel assembly of claim 1, wherein the swivel joint is formed of a hardened low or high alloy steel material.

11. A method of assembling a swivel assembly, the method comprising:
coupling a sleeve to an outer surface of a first end fitting of a first pipe section, the sleeve having at least one sleeve groove disposed on an outer surface thereof, the at least one sleeve groove configured to fit a plurality of ball bearings therein;
coupling an insert to an inner surface of a second end fitting of a second pipe section, the insert having at least one insert groove disposed on an inner surface thereof, the at least one insert groove configured to align with the at least one sleeve groove to define at least one bearing raceway therebetween when the swivel assembly is fully assembled;
inserting the sleeve into the insert, thereby fluidly coupling the first and second pipe sections via the swivel assembly; and
disposing the plurality of ball bearings into the at least one bearing raceway of the swivel assembly.

12. The method of claim 11, wherein coupling the sleeve to the outer surface comprises engaging, via corresponding threads, the sleeve and the first end fitting.

13. The method of claim 11, wherein the outer surface of the first end fitting defines a reduced outer diameter surface, and coupling the sleeve to the outer surface comprises disposing the sleeve around the reduced outer diameter surface.

14. The method of claim 11, wherein coupling the insert to the inner surface comprises engaging, via corresponding threads, the insert and the second end fitting.

15. The method of claim 11, wherein the insert is formed of a hardened low or high alloy steel material.

16. The method of claim 11, wherein the first and second end fittings are formed of a corrosion-resistant material and the insert and sleeve are formed of a material that is different from the material of the first and second end fittings.

17. A swivel assembly comprising:
a first pipe section having a first end fitting having an inner surface and an outer surface, at least a portion of the first pipe section formed of a corrosion-resistant material;
a second pipe section having a second end fitting having an inner surface and an outer surface, at least a portion of the second pipe section formed of the corrosion-resistant material; and
a swivel joint, the swivel joint rotatably securing the first and second end fittings together along a central axis, the swivel joint formed of a material having a greater hardness than the corrosion-resistant material of the first and second pipe sections.

18. The swivel assembly of claim 17, wherein the swivel joint includes a sleeve disposed on the outer surface of the first end fitting and an insert disposed on the inner surface of the second end fitting.

19. The swivel assembly of claim 18, wherein the sleeve is threadedly secured to the first end fitting.

20. The swivel assembly of claim 18, wherein the insert is threadedly secured to the second end fitting.
